(19) United States
(12) Patent Application Publication
(10) Pub. No.: US 2020/0153712 A1
(43) Pub. Date: May 14, 2020

(54) METHOD FOR OBTAINING QOE INFORMATION, TERMINAL, AND NETWORK DEVICE

(71) Applicant: HUAWEI TECHNOLOGIES CO., LTD., Shenzhen (CN)

(72) Inventors: Jinhua MIAO, Shenzhen (CN); Jian ZHANG, Beijing (CN); Xun TANG, Beijing (CN)

(21) Appl. No.: 16/741,436

(22) Filed: Jan. 13, 2020

Related U.S. Application Data
(63) Continuation of application No. PCT/CN2017/094265, filed on Jul. 25, 2017.

(51) Int. Cl. H04L 12/24; H04N 21/4363; H04N 21/845; H04N 21/231

(52) U.S. Cl. CPC H04L 41/5067; H04L 41/509; H04N 21/23106; H04N 21/8456; H04N 21/43637

(57) ABSTRACT

This application discloses a method for obtaining QoE information, a terminal, and a network device. The method may include: receiving, by the terminal, a QoE information reporting policy delivered by the network device; and reporting the QoE information to the network device based on the QoE information reporting policy, to enable the network device to schedule radio resources based on the reported QoE information, where the radio resources are used to transmit video service information for the terminal. By implementing this application, based on the QoE information reported by the terminal, the network device can learn of a video status and schedule the radio resources for a video service of the terminal, to ensure that a video can be normally played, thereby improving user experience and QoE.

### CROSS-REFERENCE TO RELATED APPLICATIONS

This application is a continuation of International Application No. PCT/CN2017/094265, filed on Jul. 25, 2017, the disclosure of which is hereby incorporated by reference in its entirety.

### TECHNICAL FIELD

This application relates to the field of wireless communications technologies, and, in particular, to a method for obtaining QoE information, a terminal, and a network device.

### BACKGROUND

With the rapid development of mobile Internet services, more users begin to use an intelligent terminal to watch a video on-live or a video on demand. There are a large quantity of resource requirements for streaming media services that are simultaneously transmitted and played, such as a video on-live and a video on demand. The streaming media services are mainstream services of mobile communication. However, how to effectively perform management and allocation of radio resources is a difficulty of mobile communication.

Currently, the radio resources are managed and allocated mainly based on quality of experience (QoE) of a user, to resolve problems such as a network latency, blocking, or the like. The QoE is defined as a real perception level of a user for a service, and directly reflects a recognition level of the user for performance of a service provided by a mobile network.

There are mainly the following two methods for evaluating the QoE.

In a first method, a user subjective evaluation score is reported. A measurement person uses a given streaming media service, and subjectively scores the service based on a mean opinion score (MOS) method. As shown in Table 1, the MOS method divides subjective perception of the QoE into five levels. This evaluation method consumes a large amount of time, and it is difficult to obtain a consistent evaluation result among all measurement persons.

TABLE 1
Mean opinion score

| MOS | QoE | Damaging level |
|---|---|---|
| 5 | Excellent | Imperceptible |
| 4 | Good | Perceptible but not severe |
| 3 | Medium | Slight |
| 2 | Inferior | Severe |
| 1 | Bad | Very severe |

In a second method, objective deduction is performed by using device performance indicators. A network key performance indicator is mapped to the QoE by using a mapping model. The KPI includes network performance indicators such as a packet loss rate, a bit error rate, a jitter, a latency, and the like. The KPI is a performance indicator of a network element, and cannot be simply mapped in a mathematical relation to the QoE. Therefore, the method is inaccurate. In addition, the KPI reflects a network status and cannot reflect quality of a streaming media service. Consequently, a network device cannot schedule the radio resources based on the quality of the streaming media service.

### SUMMARY

In embodiments of this application, a method for obtaining QoE information, and related devices are provided. A network device can schedule, based on the QoE information reported by a terminal, radio resources for a video service of the terminal, and can ensure that a video can be normally played, thereby improving user experience and QoE.

According to a first aspect, this application provides a method for obtaining QoE information, and the method is applied to a terminal and includes: receiving, by a terminal, a QoE information reporting policy delivered by a network device; and reporting the QoE information to the network device based on the QoE information reporting policy, to enable the network device to schedule radio resources based on the reported QoE information.

In one embodiment, the terminal receives a QoE information measurement policy delivered by the network device; and measures the QoE information based on the QoE information measurement policy.

In one embodiment, the terminal receives QoE configuration information delivered by the network device, where the QoE configuration information includes at least one of the QoE information measurement policy and the QoE information reporting policy. The QoE configuration information may be implemented as radio resource control signaling.

In this application, the QoE information measurement policy includes at least one of measured content and a measurement period. The measured content can reflect video quality, and is a parameter related to the video. The measured content may include: at least one of a video cache size, a video total size, video segment information, and a video playing state, where video segment data includes information about at least one segment, the data of the one segment includes at least one of a segment size and a starting and stopping time, and the video playing state is an emergency state or a non-emergency state. The measurement period is used to indicate a period length in which the terminal measures the QoE information.

It can be understood that the QoE information reporting policy includes at least one of reported content and a reporting period. The reported content and the reporting period are similar to the foregoing measured content and measurement period, and details are not described herein again.

In one embodiment, before the receiving, by a terminal, a QoE information reporting policy delivered by a network device, the method further includes: notifying, by the terminal, the network device that a current service type is a video service, to enable the network device to allocate initial radio resources to the terminal, where the initial radio resources are used for initial caching of the video service of the terminal.

Herein, the terminal may notify the network device in the following manners that the current service type is the video service:

in a first manner, the terminal establishes a default bearer with the network device, and notifies, by using RRC signaling, the network device that the current service type is the video service, or notifies, by using a preset flow ID, the network device that the current service type is the video service;

in a second manner, the terminal establishes a dedicated bearer with the network device, and notifies, by using a preset flow ID, the network device that the current service type is the video service; or in a third manner, the terminal reports an initial data packet type to the network device, to notify the network device that the current service type is the video service.

According to a second aspect, this application provides a method for obtaining QoE information, and the method is applied to a network device and includes: delivering, by a network device, a QoE information reporting policy to a terminal; receiving the QoE information reported based on the QoE information reporting policy by the terminal; and scheduling radio resources based on the reported QoE information.

In one embodiment, the network device delivers a QoE information measurement policy to the terminal.

Herein, for the QoE information measurement policy and the QoE information reporting policy, refer to the related descriptions in the first aspect.

In one embodiment, scheduling, by the network device, the radio resources based on content of the reported QoE information may include the following cases:

In a first case, when the reported content includes the video cache size, and when the video cache size is less than a first preset threshold, the radio resources are increased to transmit video service information of the terminal; or when the video cache size is greater than the first preset threshold, the radio resources are reduced or maintained to transmit the video service information of the terminal.

In a second case, when the reported content includes the video cache size and the video total size, and when a ratio of the video cache size to the video total size is less than a second preset threshold, the radio resources are increased to transmit a video service of the terminal; or when the ratio of the video cache size to the video total size is greater than the second preset threshold, the radio resources are reduced or maintained to transmit the video service information of the terminal.

In a third case, when the reported content includes the video playing state, and when the video playing state is the emergency state, the radio resources are increased to transmit a video service of the terminal; or when the video playing state is the non-emergency state, the radio resources are reduced or maintained to transmit a video service of the terminal.

It can be understood that the radio resources are maintained by the network device to transmit the video service information of the terminal means that the network device does not configure more radio resources for the terminal, and does not reduce the radio resources already configured for the terminal, so that the radio resources used by the terminal to transmit the video service information keep unchanged.

In one embodiment, the network device may receive a notification sent by the terminal that a current service type is a video service, and allocate initial radio resources to the terminal based on the notification, where the initial radio resources are used for initial caching of the video service of the terminal. Herein, for an embodiment in which the network device receives the notification sent by the terminal that the current service type is the video service, refer to the related descriptions in the first aspect.

According to a third aspect, this application provides a terminal, configured to perform the method described in the first aspect. The terminal may include: a memory, and a processor, a transmitter, and a receiver that are coupled to the memory. The transmitter is configured to send a signal to a network device or another terminal. The receiver is configured to receive a signal sent by the network device or another terminal. The memory is configured to store implementation code of the method described in the first aspect. The processor is configured to execute the program code stored in the memory, that is, perform the method provided in any one of the first aspect or the possible embodiments of the first aspect.

According to a fourth aspect, this application provides a network device, configured to perform the method described in the second aspect. The network device may include: a memory, and a processor, a transmitter, and a receiver that are coupled to the memory. The transmitter is configured to send a signal to another network device or a terminal. The receiver is configured to receive a signal sent by another network device or the terminal. The memory is configured to store implementation code of the method described in the second aspect. The processor is configured to execute the program code stored in the memory, that is, perform the method provided in any one of the second aspect or the possible embodiments of the second aspect.

According to a fifth aspect, a terminal is provided, including a receiving unit and a sending unit, where the receiving unit is configured to receive a QoE information reporting policy delivered by a network device; and the sending unit is configured to report QoE information to the network device based on the QoE information reporting policy, to enable the network device to schedule radio resources based on the reported QoE information.

It can be understood that function units included in the terminal may be configured to perform the method in the first aspect, and refer to the foregoing descriptions for details.

According to a sixth aspect, a network device is provided, including a receiving unit, a sending unit, and a processing unit, where the sending unit is configured to deliver a QoE information reporting policy to a terminal;

the receiving unit is configured to receive QoE information reported based on the QoE information reporting policy by the terminal; and

the processing unit is configured to schedule radio resources based on the reported QoE information, where the radio resources are used to transmit video service information for the terminal.

It can be understood that function units included in the network device may be configured to perform the method in the second aspect, and refer to the foregoing descriptions for details.

According to a seventh aspect, a computer-readable storage medium is provided, including an instruction. When run on a computer, the instruction enables the computer to perform the method described in the first aspect.

According to an eighth aspect, a computer program product including an instruction is provided. When run on a computer, the program enables the computer to perform the method described in the first aspect.

According to a ninth aspect, a computer-readable storage medium is provided, including an instruction. When run on a computer, the instruction enables the computer to perform the method described in the second aspect.

According to a tenth aspect, a computer program product including an instruction is provided. When run on a computer, the program enables the computer to perform the method described in the second aspect.

By implementing this application, based on the QoE information reported by the terminal, the network device can learn of video quality and schedule the radio resources for the video service of the terminal, to ensure that a video can be normally played, thereby improving user experience and the QoE.

### BRIEF DESCRIPTION OF DRAWINGS

To describe the technical solutions in this application or in the background more clearly, the following describes the accompanying drawings required for describing this application or the background.

FIG. 1 is a diagram of a network architecture of a communications system according to this application;

FIG. 2 is a schematic flowchart of a method for obtaining QoE information according to this application;

FIG. 3 is a schematic flowchart of another method for obtaining QoE information according to this application;

FIG. 4A and FIG. 4B are a schematic diagram of a hardware architecture of a terminal according to this application;

FIG. 5 is a schematic diagram of a hardware architecture of a network device according to this application; and

FIG. 6 is a schematic structural diagram of a terminal and a network device according to this application.

### DESCRIPTION OF EMBODIMENTS

The following describes this application with reference to the accompanying drawings in this application.

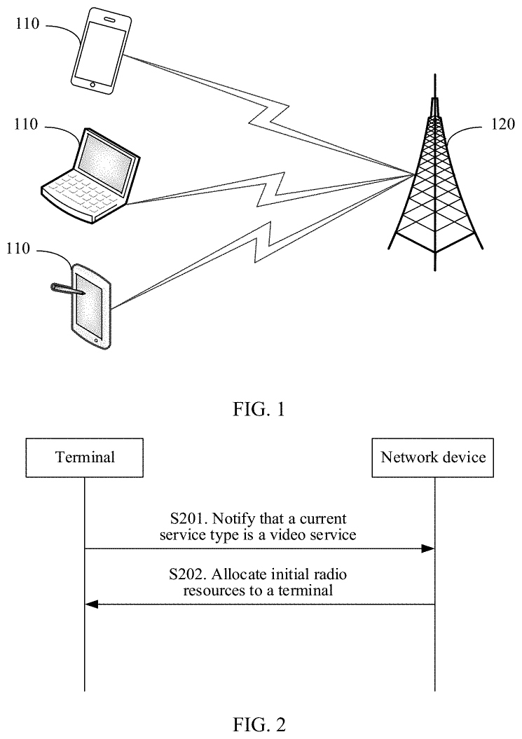

FIG. 1 is a diagram of a network architecture of a communications system 100 according to this application. The communications system includes a terminal 110 and a network device 120. The terminal 110 and the network device 120 communicate with each other by using an air interface technology. The air interface technology may include: current 2G (for example, a global system for mobile communications), 3G (for example, a universal mobile telecommunications system), wideband code division multiple access, time division-synchronous code division multiple access, 4G (for example, FDD LTE and TDD LTE), and a new radio access technology, such as forthcoming 4.5 G and 5G.

The terminal 110 supports wireless receiving and transmitting functions, and cooperates with the network device 120 to provide a data service for a user. The terminal 110 may be, but not limited to, user equipment such as a smartphone that can support a streaming media service, a tablet computer, a media player, a smart television, a smart band, a smart wearable device, an MP3 (Moving Picture Experts Group Audio Layer III) player, an MP4 (Moving Picture Experts Group Audio Layer IV) player, a personal digital assistant, a laptop portable computer, or the like.

The network device 120 may be a device configured to communicate with the terminal 110, for example, may be a BTS in the GSM or CDMA, may be an NB in the WCDMA, or may be an evolved NodeB in LTE, a relay station, an in-vehicle device, a wearable device, an access network device (for example, gNodeB, gNB) in a future 5G network, an access network device in a future evolved public land mobile network, or the like.

Based on the foregoing communications system, this application provides a method for obtaining QoE information and video quality can be reflected by using the QoE information, so that a network device can better schedule radio resources based on the QoE information and improve quality of a communications service.

To better understand this application, two time phases for a video service performed between the terminal and the network device are first introduced: One is an initialization phase before the video service is formally transmitted, and the other is a transmission phase in which the video service is formally transmitted.

In the initialization phase, no video service is transmitted between the terminal and the network device, and preparation may be made for subsequent formal transmission of the video service. For example, the network device allocates the radio resources to the terminal.

In the transmission phase, the video service is transmitted between the terminal and the network device, and the transmission phase is a time period from starting to transmit the video service by the terminal and the network device to finishing transmitting the video service.

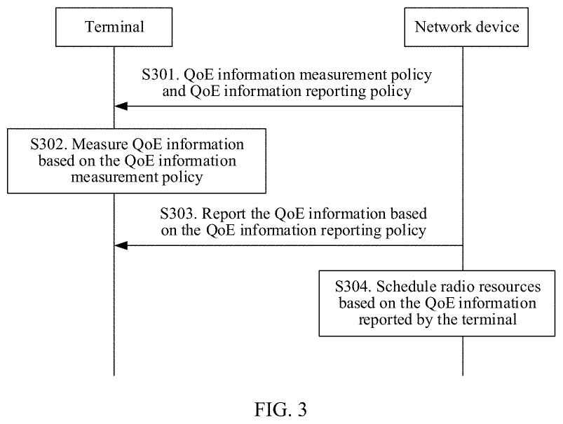

FIG. 2 is a schematic flowchart of a method for obtaining QoE information according to this application. The method may be applied to an initialization phase. A terminal notifies a network device that a video service needs to be initiated currently, so that the network device allocates radio resources to the terminal. The method may include the following operations.

S201. The terminal notifies the network device that a current service type is the video service.

In this application, the terminal may notify the network device in the following three manners that the current service type is the video service:

In a first manner, after a default bearer is established between the terminal and the network device, the terminal notifies, by using RRC signaling, the network device that the current service type is the video service.

In one embodiment, after an RRC connection of the terminal is set up, a core network establishes a default information radio bearer for the terminal, and the default bearer is used for an information service that has a small information amount and low real-time performance. In this application, the default bearer forms an information transmission channel from the core network to the network device to the terminal or in a reversed direction. Herein, it can be considered that the default bearer is established between the terminal and the network device.

In one embodiment, after the default bearer is established between the terminal and the network device, the terminal may notify the network device in an event triggering manner that the current service type is the video service. For example, an application run on the terminal may instruct an RRC layer of the terminal to notify, by using the RRC signaling, an RRC layer of the network device that the current service type is the video service.

In one embodiment, after the default bearer is established between the terminal and the network device, a service flow ID may be added to information sent by using the default bearer, and the network device may be notified, by using the service flow ID, that the current service type is the video service. A service flow, such as a video service, a voice service, or the like, may be distinguished when different values are assigned to the service flow ID. In this application, a value of a video service flow ID may be prescribed between the terminal and the network device. For example, the video service flow ID may be prescribed as 1. When a service flow ID reported by the terminal to the network device is 1, the network device can learn of that the current service type is the video service. It should be understood that the foregoing example is merely used to describe this application, and should not constitute limitations.

In a second manner, a dedicated bearer is established between the terminal and the network device, and the terminal notifies, by using a preset flow ID, the network device that the current service type is the video service.

In one embodiment, after the core network establishes the default bearer for the terminal, if the default bearer cannot meet a current service requirement, the core network establishes the dedicated bearer for the terminal. The dedicated bearer is used for service transmission with higher requirements (a high rate, a low latency, and the like). In this application, the dedicated bearer forms an information transmission channel from the core network to the network device to the terminal or in a reversed direction. Herein, it can be considered that the dedicated bearer is established between the terminal and the network device.

After the dedicated bearer is established between the terminal and the network device, the terminal may notify, by using the flow ID, the network device that the current service type is the video service. This is similar to notifying, in the default bearer by using the flow ID, the network device that a current service type is the video service. Details are not described herein again.

In a third manner, the terminal reports an initial data packet type to the network device, to notify the network device that the current service type is the video service.

In one embodiment, the terminal indicates, by using the RRC signaling, the initial data packet type to the network device. In one embodiment, the terminal indicates to the network device that the initial data packet type is the video type, that is, may enable the network device to learn of that the current service type is the video service.

S202. The network device allocates initial radio resources to the terminal.

In one embodiment, when learning of that the current service type is the video service, the network device may allocate the initial radio resources to the terminal that are used for initial caching of the video service of the terminal. The radio resources herein may include spectrum resources, time domain resources, and the like.

Further, when the network device learns of that the current service type is the video service, radio resources allocated to the terminal may be superior to radio resources allocated to other services, to speed up the initial caching of the video service of the terminal.

Further, when learning of that the current service type is the video service, the network device may allocate the radio resources to the terminal in priority, to speed up the initial caching of the video service of the terminal.

It can be understood that the foregoing operations S201 and S202 are both performed in the initialization phase.

The foregoing operations S201 and S202 are implemented. After the network device allocates the initial radio resources to the terminal, the terminal may perform the initial caching by using the radio resources in the transmission phase.

In one embodiment, when the video service begins, the initial caching is used by the terminal to ensure that video images watched by a user have a buffer phase, so that watching is kept smooth. It can be understood that after the terminal initiates a video service request, the video images can be formally presented to the user only after the initial caching is finished.

The terminal uses the initial radio resources allocated by the network device (allocated in priority or superior radio resources are allocated), to speed up initialized caching of the video service in the transmission phase, and reduce an initialization latency, so that the terminal can initiate the video service more quickly. In terms of user experience, a time length from initiating a service requirement by the user to actually seeing the video service by the user is reduced, so that user experience can be improved, and the QoE is further improved.

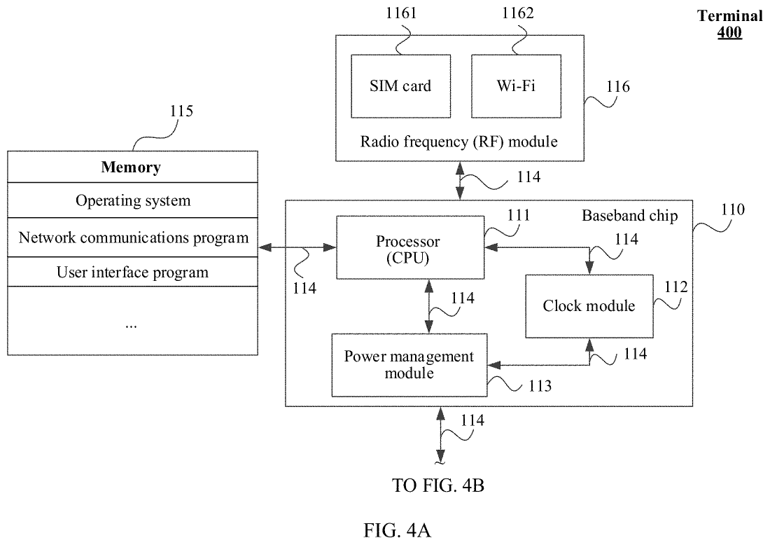

To enable the network device to better perform optimized scheduling on the radio resources, this application further provides another method for obtaining QoE information. The method may be mainly used in a transmission phase. The network device schedules radio resources for a terminal based on real-time quality of a current video, to improve video quality and user experience. With reference to FIG. 3, the method may be implemented based on the method shown in FIG. 2, or may be implemented independent of the method shown in FIG. 2. The method may include the following operations.

S301. The network device delivers a QoE information measurement policy and a QoE information reporting policy to the terminal.

In one embodiment, the network device delivers QoE configuration information to the terminal, where the QoE configuration information includes at least one of the QoE information measurement policy and the QoE information reporting policy. The QoE configuration information may be implemented as RRC signaling.

In one embodiment, the network device may first deliver the QoE information measurement policy to the terminal, and then deliver the QoE information reporting policy to the terminal.

In one embodiment, the network device may deliver the QoE information measurement policy and the QoE information reporting policy to the terminal in the transmission phase. In one embodiment, the network device may further deliver the QoE information measurement policy and the QoE information reporting policy to the terminal in the initialization phase. During actual application, an occasion on which the network device delivers the QoE information measurement policy and the QoE information reporting policy to the terminal may be set based on actual requirements.

In one embodiment, the network device may deliver, by using RRC signaling or non-access stratum signaling, the QoE information measurement policy and the QoE information reporting policy to the terminal in a manner of increasing a message type or adding a field to a current message type during control signaling or message exchange with the terminal in the initialization phase or in the transmission phase.

The QoE information measurement policy and the QoE information reporting policy that are delivered by the network device to the terminal may be determined by a network device based on pre-stored factors such as user information, a network environment, a terminal configuration, and the like that correspond to the terminal.

In this application, the QoE information measurement policy may include at least one of measured content and a measurement period, and may further include information such as whether to perform measurement on the QoE information, how to measure the QoE information, and the like. This is not limited in this application. The following describes in detail a case in which the QoE information measurement policy includes the measured content and the measurement period.

The measured content in the QoE information measurement policy can reflect video quality, is a parameter related to a video, and may include one or more of the following items:

(1) Video Cache Size

Herein, the video cache size is a size of a video already cached on a current terminal. The measurement unit may be a storage capacity occupied by the cached video, such as KB, M, G, or the like, or may be a playable time length of the cached video, such as a second, a minute, or the like.

The video cache size may be a fixed value prescribed between the network device and the terminal, or may be related to a current network environment. When the network environment is good, the video cache is relatively large, and when the network environment is poor, the video cache is relatively small.

(2) Video Total Size

Herein, the video total size and the video cache size are similar, and the measurement unit may also be the occupied storage capacity, or the playable length.

The video total size is related to the video and is not affected by any external factor. For example, a size of a TV episode may be 45 min, and a size of a movie may be 120 min.

(3) Video Segment Information

Generally, an entire video has a relatively large length. Therefore, when providing a video service to the terminal, the network device does not send the entire video to the terminal, to prevent the terminal from exiting when the video is played, which otherwise causes some of video content not to be played, and radio resources that are used to transmit the video content that is not played are wasted. Usually, the network device divides a video into several segments of sub-videos with smaller sizes, and separately sends, in a chronological order, the several segments of sub-videos to the terminal. The video segment information herein is information of the several segments of sub-videos.

In one embodiment, the video segment information may include sizes or starting and stopping times of one or more video segments, or may simultaneously include sizes and starting and stopping times of one or more video segments. The measurement unit of the video segment may also be the occupied storage capacity, or the playable length. The starting and stopping time means a starting time and an ending time of a video segment in the entire video. For example, an entire 45-minute video may include three segments of sub-videos. Separate sizes and starting and stopping times of the three segments of sub-videos may be shown in the following Table 2.

TABLE 2

| Sub-video | Size | Starting and stopping time |
|---|---|---|
| First sub-video | 10 minutes | 0 minute to 10 minute |
| Second sub-video | 15 minutes | 10 minute to 25 minute |
| Third sub-video | 20 minutes | 25 minute to 45 minute |

(4) Video Playing State

In this application, the video playing state may be an emergency state or a non-emergency state. The emergency state indicates that a current video cannot be normally played, and there may be situations, such as video freezes, discontinuous images, and the like, that prevent a user from normally watching the video. The non-emergency state indicates that the current video can be normally played, and the user is not prevented from normally watching the video.

In one embodiment, in addition to the foregoing two video states: the emergency state and the non-emergency state, the video playing state may be divided into more levels. For example, the video playing state may be divided into levels such as high emergency, relative emergency, normal emergency, and non-emergency, and a current video playing state is determined based on a situation.

During implementation, in addition to the foregoing four pieces of measured content, the measured content in the QoE information measurement policy may further include richer parameters or information related to the video quality, such as a video MOS, a rate of synchronization between a voice and an image, and the like. This is not limited in this application.

The measurement period in the QoE information measurement policy is used to indicate a time interval between two measurements by the terminal on the QoE information. For example, if the measurement period is 1 min, the terminal measures the QoE information once every other minute.

In this application, the QoE information reporting policy may include at least one of reported content and a reporting period, and may further include information such as whether to report the QoE information, how to report the QoE information, and the like. This is not limited in this application. The reported content and the reporting period in the QoE information reporting policy are similar to the measured content and the measurement period in the QoE information measurement policy, and refer to the foregoing related content. Details are not described herein again.

S302. The terminal measures the QoE information based on the QoE information measurement policy.

In one embodiment, the terminal measures, based on the measurement period in the QoE information measurement policy delivered by the network device, the measured content in the QoE information measurement policy at a corresponding time. The following describes, by using an example, a manner in which the terminal measures the QoE information.

A cached video is temporarily stored in the terminal. Therefore, when the measured content includes the video cache size, the application layer of the terminal stores a size of a corresponding cached video. An RRC layer of the terminal may obtain a parameter of the video cache size in the APP layer in an inter-layer interaction manner.

When providing a video service for the terminal and exchanging information with the terminal, the network device notifies the terminal of a total size of a video currently requested by the terminal. Therefore, when the measured content includes the video total size, the terminal may extract content of the video total size from the information exchanged with the network device.

When providing a video service for the terminal and exchanging information with the terminal, the network device notifies the terminal of information about several segments of sub-videos. Therefore, when the measured content includes the video segment information, the terminal may extract the video segment information from the information exchanged with the network device.

When the measured content includes the video playing state, the terminal may determine a current video playing state based on a situation. In one embodiment, the terminal may determine whether a current video cache size is greater than a first value. If the current video cache size is greater than the first value, the current video state is determined to be the non-emergency state, or if the current video cache size is less than the first value, the current video state is determined to be the emergency state. In one embodiment, the terminal may further determine whether a ratio of a current video cache size to the video total size is greater than a second value. If the ratio of the current video cache size to the video total size is greater than the second value, the current video state is determined to be the non-emergency state, and if the ratio of the current video cache size to the video total size is less than the second value, the current video state is determined to be the emergency state. The first value and the second value are both preset by the terminal. During implementation, in addition to the foregoing two cases, the terminal may further determine the current video playing state based on other factors.

In addition to the foregoing manner in which the terminal measures the QoE information, the terminal may further measure the QoE information in other manners. This is not limited in this application.

S303. The terminal reports the QoE information to the network device based the QoE information reporting policy.

In one embodiment, the terminal reports, based on the reporting period in the QoE information reporting policy delivered by the network device, reported content in the QoE information reporting policy at a corresponding time.

It can be understood that measurement and reporting of the QoE information are independent of each other. The reported content in the QoE information reporting policy and the measured content in the QoE information measurement policy are different. That is, the network device may require the terminal to measure some content, but not require the terminal to report all measured content. The reporting period in the QoE information reporting policy and the measurement period in the QoE information measurement policy may also be different from each other.

When reporting the QoE information to the network device, the terminal may encapsulate corresponding content as a data packet, and send the data packet to the network device by using a current message type or a newly added message type.

S304. The network device schedules radio resources based on the QoE information reported by the terminal, where the radio resources are used to transmit video service information for the terminal.

In one embodiment, the network device analyzes the QoE information reported by the terminal, and adjusts the radio resources allocated to the video service of the terminal. The radio resources herein may be time domain resources or spectrum resources. Further, when scheduling the radio resources for the terminal, the network device may further perform operations, such as power control, packet scheduling, flow control, adaptive modulation and coding, radio resources reservation, and the like, on the video service of the terminal.

In this application, the network device schedules the radio resources based on content in the QoE information reported by the terminal. The following provides detailed descriptions by using different cases.

(1) The Reported QoE Information Includes the Video Cache Size.

When the reported QoE information includes the video cache size, and when the video cache size is less than a first preset threshold, the network device increases the radio resources to transmit video service information of the terminal; or when the video cache size is greater than a first preset threshold, the network device reduces or maintains the radio resources to transmit video service information of the terminal. The first preset threshold is preset by the network device.

The foregoing case is equivalent to a case in which the network device schedules more radio resources to support the video service of the terminal when the video cache size is intermediate or excessively small, to prevent situations such as video freezes, discontinuous images, and the like when a video is played; or when the video cache size is relatively large, it indicates that the current video playing of the terminal has no problems, and the network device does not need to schedule more radio resources for the terminal. In this way, existing radio resources can be fully used.

(2) The Reported QoE Information Includes the Video Cache Size and the Video Total Size.

When the reported QoE information includes the video cache size and the video total size, and when a ratio of the video cache size to the video total size is less than a second preset threshold, the network device increases the radio resources allocated to the terminal to transmit the video service information of the terminal; or when a ratio of the video cache size to the video total size is greater than a second preset threshold, the radio resources are reduced or maintained to transmit the video service information of the terminal.

In one embodiment, for example, assuming that the second preset threshold is 70%, and if the video cache size is 1 s and the video total size is 5 s, the radio of the video cache size to the video total size is 20% and is less than the second preset threshold, so that the network device may schedule more radio resources for the terminal; or if the video cache size is 1 s and the video total size is 1 s, the radio of the video cache size to the video total size is 100% and is greater than the second preset threshold, so that the network device does not need to schedule more radio resources for the terminal. The second preset threshold is preset by the network device.

(3) The Reported QoE Information Includes the Video Cache Size and the Video Segment Information.

When the reported QoE information includes the video cache size and the video segment information, the network device calculates the video cache size and a relationship between sub-videos in the video segment information, and adjusts the radio resources to transmit the video service information of the terminal.

In one embodiment, for example, assuming that the video cache size is 15 min and the segment information is shown in the foregoing Table 2, it can be learned of that the video total size is 45 min, and in this case, the network device may schedule more radio resources for the terminal to transmit the video service information of the terminal; or if the video cache size is 40 min, the network device does not need to schedule more radio resources for the terminal.

It can be understood that the foregoing is merely an example. During implementation, the network device may further schedule the radio resources for each sub-video based on the video segment information.

(4) The Reported QoE Information Includes the Video Playing State.

When the reported QoE information includes the video playing state, and when the video playing state is the emergency state, the network device increases the radio resources to transmit the video service information of the terminal; or when the video playing state is the non-emergency state, the network device reduces or maintains the radio resources to transmit the video service information of the terminal.

It can be understood that the network device maintains the radio resources to transmit the video service information of the terminal means that the network device does not configure more radio resources for the terminal, and does not reduce the radio resources already configured for the terminal, so that the radio resources used by the terminal to transmit the video service information keep unchanged.

It can be understood that the foregoing operations S302 to S304 are all performed in the transmission phase.

By implementing the method shown in FIG. 3, based on the QoE information reported by the terminal, the network device can learn of video quality and schedule the radio resources for the video service of the terminal, to ensure that a video can be normally played, thereby improving user experience and the QoE.

The methods in this application are described in detail above. For ease of better implementing the foregoing solutions in this application, this application further provides corresponding apparatuses.

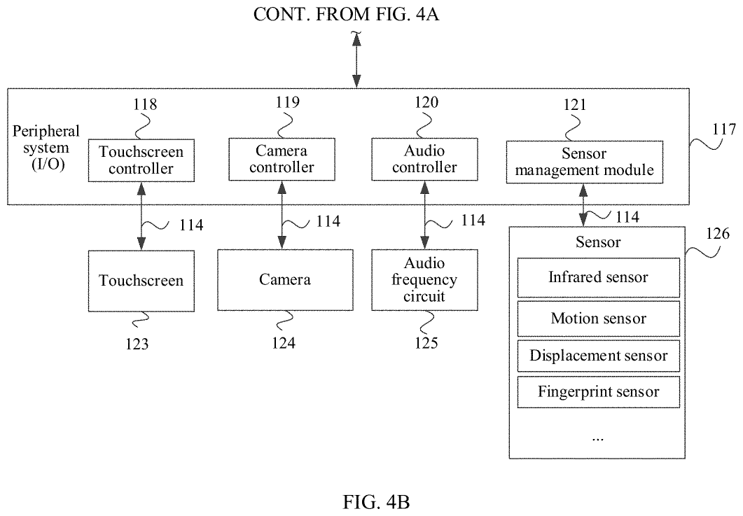

FIG. 4A and FIG. 4B are a structural block diagram of an embodiment of a terminal 400 according to this application. As shown in FIG. 4A and FIG. 4B, the terminal 400 may include: a baseband chip 110, a memory 115 (one or more computer-readable storage media), a radio frequency module 116, and a peripheral system 117. These components may communicate on one or more communications buses 114.

The peripheral system 117 is mainly configured to implement a function of interaction between the terminal 400 and a user/external environment, and mainly includes an input/output apparatus of the terminal 400. During implementation, the peripheral system 117 may include: a touchscreen controller 118, a camera controller 119, an audio controller 120, and a sensor management module 121. Each controller may be coupled to a corresponding peripheral device (such as a touchscreen 123, a camera 124, an audio frequency circuit 125, and a sensor 126). It should be noted that the peripheral system 117 may further include another I/O peripheral device.

The baseband chip 110 may include in an integrated manner: one or more processors 111, a clock module 112, and a power management module 113. The clock module 112 integrated in the baseband chip 110 is mainly configured to generate a clock, required by information transmission and timing control, for the processor 111. The power management module 113 integrated in the baseband chip 110 is mainly configured to provide stable and high-precision voltages for the processor 111, the radio frequency module 116, and the peripheral system.

The radio frequency module 116 is configured to: receive and send a radio frequency signal, and mainly integrates a receiver and a transmitter of the terminal 400. The radio frequency module 116 communicates with a network device and another communications device by using the radio frequency signal. During implementation, the radio frequency module 116 may include but is not limited to: an antenna system, an RF transceiver, one or more amplifiers, a tuner, one or more oscillators, a digital signal processor, a CODEC chip, a SIM card, a storage medium, and the like. In some embodiments, the radio frequency module 116 may be implemented on a separate chip. In this application, the radio frequency module 116 may be configured to exchange information with the network device.

The memory 115 is coupled to the processor 111, and is configured to store various software programs and/or a plurality of groups of instructions. During implementation, the memory 115 may include a high-speed random access memory, and may also include a non-volatile memory such as one or more magnetic disk storage devices, a flash memory device, or another non-volatile solid-state storage device. The memory 115 may store an operating system (briefly referred to as a system below), for example, an embedded operating system such as ANDROID, IOS, WINDOWS, LINUX, or the like. The memory 115 may further store a network communications program, and the network communications program may be configured to communicate with one or more adjuncts, one or more terminal devices, and one or more network devices. The memory 115 may further store a user interface program, and the user interface program may visually and vividly display content of an application by using a graphical operation interface, and receive, by using input controls such as a menu, a dialog box, a key, and the like, a control operation of the user for the application.

It should be understood that the terminal 400 is merely an example provided in this application. Moreover, the terminal 400 may have components more or fewer than the shown components, may combine two or more components, or may have different configuration of components.

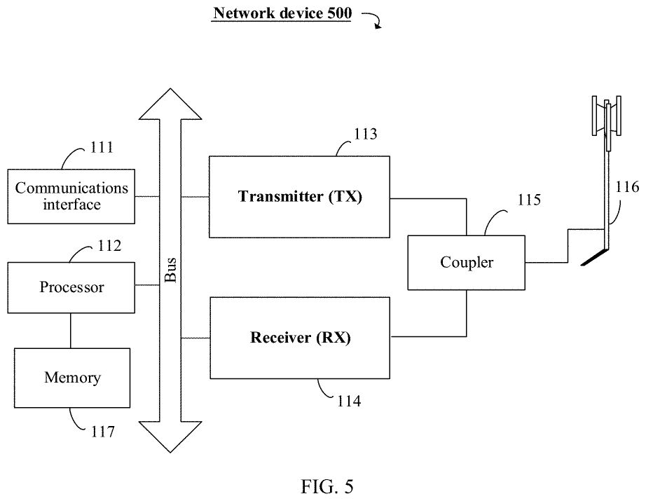

FIG. 5 is a structural block diagram of an embodiment of a network device 500 according to this application. The network device may include: a communications interface 111, one or more processors 112, a transmitter 113, a receiver 114, a coupler 115, an antenna 116, and a memory 117. These components may be connected through a bus or in another manner. In FIG. 5, the connection through the bus is used as an example.

The communications interface 111 may be configured for the network device 500 to communicate with another communications device, such as a terminal, another network device, or the like. During implementation, the communications interface 111 may be a network communications interface, such as an LTE communications interface, a 5G communications interface, or a communications interface with a new air interface in the future. In addition to a wireless communications interface, a wired communications interface may further be configured in the network device 500 to support wired communications.

The antenna 116 may be configured to: convert electromagnetic energy in a transmission cable into an electromagnetic wave in a free space, or convert the electromagnetic wave in the free space into the electromagnetic energy in the transmission cable. The coupler 115 may be configured to: divide communications signals into a plurality of paths and allocate the communications signals to a plurality of processors 114.

The transmitter 113 may be configured to transmit a signal output by the processor 112, and configured to transmit a signal to the terminal or another network device. The receiver 114 may be configured to receive a signal received by the antenna 116, and configured to receive a signal transmitted by the terminal or another network device. There may be one or more transmitters 113 and one or more receivers 114.

In this application, the transmitter 113 is configured to send a QoE information measurement policy and a QoE information reporting policy to the terminal.

The memory 117 is coupled to the processor 112, and is configured to store various software programs and/or a plurality of groups of instructions. During implementation, the memory 117 may include a high-speed random access memory, and may also include a non-volatile memory such as one or more magnetic disk storage devices, a flash memory device, or another non-volatile solid-state storage device. The memory 117 may store an operating system (briefly referred to as a system below), for example, an embedded operating system such as uCOS, VxWorks, RTLinux, or the like. The memory 117 may further store a network communications program, and the network communications program may be configured to communicate with one or more adjuncts, one or more terminal devices, and one or more network devices.

In some embodiments in this application, the memory 117 may be configured to store an implementation program that is of the method for obtaining QoE information provided in one or more embodiments in this application and that is on the network device 500. For the implementation of the method for obtaining QoE information provided in one or more embodiments in this application, refer to the foregoing embodiments.

The processor 112 may include: an administration module/communication module (used in a center of speech channel interaction and information exchange), a basic module (configured to complete call processing, signaling processing, radio resources management, radio link management and circuit maintenance functions), a transcoder and submultiplexer unit (configured to complete multiplexing/demultiplexing and transcoder functions), and the like.

In this application, the processor 112 may be configured to: read and execute a computer-readable instruction. In one embodiment, the processor 112 may be configured to: invoke a program stored in the memory 117, for example, the implementation program that is of the method for obtaining QoE information provided in one or more embodiments in this application and that is on the network device 500, and execute instructions included in the program.

During implementation, the network device 500 may be a network device in the communications system shown in FIG. 1, and may be implemented as a base transceiver station, a wireless transceiver, a basic service set, an extended service set, a NodeB, an eNodeB, and the like. The network device 500 may be implemented as different types of base stations, such as a macro base station, a micro base station, and the like.

It should be noted that the network device 500 shown in FIG. 5 is merely an embodiment of this application. During actual application, the network device 500 may further include more or fewer components. This is not limited herein.

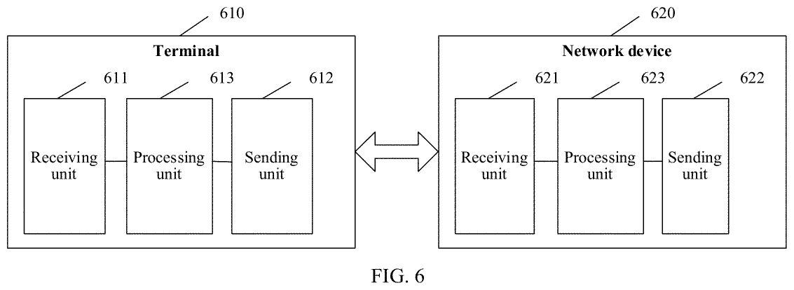

FIG. 6 is a schematic structural diagram of a terminal 610 and a network device 620 according to this application. The terminal 610 and the network device 620 may be respectively the terminal and the network device in the communications system shown in FIG. 1 or in the method embodiments shown in FIG. 2 and FIG. 3.

First, as shown in the figure, the terminal 610 may include: a receiving unit 611, a sending unit 612, and a processing unit 613, where

the receiver 611 is configured to receive a QoE information reporting policy delivered by the network device;

the sending unit 612 is configured to report QoE information to the network device based on the QoE information reporting policy, to enable the network device to schedule radio resources based on the reported QoE information;

in one embodiment, the receiving unit 611 is further configured to receive a QoE information measurement policy delivered by the network device; and

the processor unit 613 is configured to measure the QoE information based on the QoE information measurement policy.

It should be understood that, for the information measurement policy and the information reporting policy, refer to the descriptions in the foregoing method embodiment in FIG. 3, and details are not described herein again.

In one embodiment, the sending unit 612 is further configured to notify the network device that a current service type is a video service, to enable the network device to allocate initial radio resources to the terminal, where the initial radio resources are used for initial caching of the video service of the terminal.

In one embodiment, the sending unit 612 may notify, by using RRC signaling, the network device that the current service type is the video service, or notify, by using a preset flow ID, the network device that the current service type is the video service; or

notify, by using a preset flow ID, the network device that the current service type is the video service; or

report an initial data packet type to the network device, to notify the network device that the current service type is the video service.

It should be noted that functions of all function units of the apparatus 610 in all embodiments of the present application may be implemented based on the methods in the foregoing method embodiments. For an implementation processes thereof, refer to the related descriptions in the foregoing method embodiments shown in FIG. 2 and FIG. 3, and details are not described herein again.

Second, as shown in the figure, the network device 620 may include: a receiving unit 621, a sending unit 622 and a processing unit 623, where

the sending unit 622 is configured to deliver the QoE information reporting policy to the terminal;

the receiving unit 621 is configured to receive the QoE information reported based on the QoE information reporting policy by the terminal; and

the processing unit 623 is configured to schedule the radio resources based on the reported QoE information.

In one embodiment, the sending unit 622 is further configured to deliver the QoE information measurement policy to the terminal.

It should be understood that, for the information measurement policy and the information reporting policy, refer to the descriptions in the foregoing method embodiment in FIG. 3, and details are not described herein again.

In one embodiment, the processing unit 623 is configured to: increase the radio resources to transmit video service information of the terminal when the reported content includes the video cache size, and when the video cache size is less than a first preset threshold; or reduce or maintain the radio resources to transmit the video service information of the terminal when the video cache size is greater than the first preset threshold.

In one embodiment, the processing unit 623 is configured to: increase the radio resources to transmit a video service of the terminal when the reported content includes the video cache size and the video total size, and when a ratio of the video cache size to the video total size is less than a second preset threshold; or reduce or maintain the radio resources to transmit a video service of the terminal when the ratio of the video cache size to the video total size is greater than the second preset threshold.

In one embodiment, the processing unit 623 is configured to: increase the radio resources to transmit a video service of the terminal when the reported content includes the video playing state, and when the video playing state is the emergency state; or reduce or maintain the radio resources to transmit a video service of the terminal when the video playing state is the non-emergency state.

In one embodiment, the receiving unit 621 is further configured to receive a notification sent by the terminal that a current service type is the video service, and the processing unit 623 is further configured to allocate initial radio resources to the terminal based on the notification, where the initial radio resources are used for initial caching of the video service of the terminal.

In one embodiment, the receiving unit 621 is configured to: receive, by using the RRC signaling, the notification sent by the terminal that the current service type is the video service, or receive, by using the preset flow ID, the notification sent by the terminal that the current service type is the video service; or receive, by using the preset flow ID, the notification sent by the terminal that the current service type is the video service; or receive an initial data packet type reported by the terminal.

It should be noted that functions of all function units of the apparatus 620 in all embodiments of the present application may be implemented based on the methods in the foregoing method embodiments. For implementation processes thereof, refer to the related descriptions in the foregoing method embodiments shown in FIG. 2 and FIG. 3, and details are not described herein again.

All or some of the foregoing embodiments may be implemented by using software, hardware, firmware, or any combination thereof. When software is used for implementation, all or some of the embodiments may be implemented in a form of a computer program product. The computer program product includes one or more computer instructions. When the computer program instructions are loaded and executed on the computer, the procedures or functions according to this application are all or partially generated. The computer may be a general-purpose computer, a dedicated computer, a computer network, or another programmable apparatus. The computer instructions may be stored in a computer-readable storage medium, or may be transmitted from a computer-readable storage medium to another computer-readable storage medium. For example, the computer instructions may be transmitted from a website, a computer, a server, or an information center to another website, computer, server, or information center in a wired (for example, a coaxial cable, an optical fiber, or a digital subscriber line) or wireless (for example, infrared, radio, and microwave, or the like) manner. The computer-readable storage medium may be any usable medium accessible by the computer, or an information storage device, such as a server, an information center, or the like, integrating one or more usable media. The usable medium may be a magnetic medium (for example, a floppy disk, a hard disk, or a magnetic tape), an optical medium (for example, a DVD), a semiconductor medium (for example, a solid state drive or solid state disk), or the like.

What is claimed is:

1. A method for obtaining QoE information comprising:
receiving, by a terminal, a QoE information reporting policy delivered by a network device; and
reporting the QoE information to the network device according to the QoE information reporting policy to enable the network device to schedule radio resources according to the reported QoE information.

2. The method according to claim 1, wherein before reporting the QoE information to the network device, the method further comprises:
receiving, by the terminal, a QoE information measurement policy delivered by the network device; and
measuring the QoE information according to the QoE information measurement policy.

3. The method according to claim 2, wherein the QoE information measurement policy comprises measured content, and the measured content comprises: at least one of a video cache size, a video total size, video segment information, and a video playing state, wherein
the video segment information comprises information about at least one segment, the information about the at least one segment comprises at least one of a segment size and a starting and stopping time, and the video playing state includes an emergency state or a non-emergency state.

4. The method according to claim 1, wherein the QoE information reporting policy comprises reported content, and the reported content comprises: at least one of a video cache size, a video total size, video segment information, and a video playing state, wherein
the video segment information comprises information about the at least one segment, the information about the at least one segment comprises at least one of a segment size and a starting and stopping time, and the video playing state includes an emergency state or a non-emergency state.

5. The method according to claim 4, wherein the QoE information reporting policy further comprises a reporting period, and the reporting period indicates a period length in which the terminal reports the QoE information to the network device.

6. A method for obtaining QoE information comprising:
delivering, by a network device, a QoE information reporting policy to a terminal;
receiving the QoE information reported according to the QoE information reporting policy by the terminal; and
scheduling radio resources according to the reported QoE information.

7. The method according to claim 6, wherein before the receiving, by the network device, the QoE information reported according to the QoE information reporting policy by the terminal, the method further comprises:
delivering, by the network device, a QoE information measurement policy to the terminal.

8. The method according to claim 7, wherein the QoE information measurement policy comprises measured content, and the measured content comprises: at least one of a video cache size, a video total size, video segment information, and a video playing state, wherein
the video segment information comprises information about at least one segment, the information about the at least one segment comprises at least one of a segment size and a starting and stopping time, and the video playing state includes an emergency state or a non-emergency state.

9. The method according to claim 6, wherein the QoE information reporting policy comprises reported content, and the reported content comprises: at least one of a video cache size, a video total size, video segment information, and a video playing state, wherein
the video segment information comprises the information about the at least one segment, the information about the at least one segment comprises at least one of a segment size and a starting and stopping time, and the video playing state includes an emergency state or a non-emergency state.

10. The method according to claim 9, wherein the QoE information reporting policy further comprises a reporting period, and the reporting period indicates a period length in which the terminal reports the QoE information to the network device.

11. The method according to claim 9, wherein the scheduling radio resources according to the reported QoE information comprises:
when the reported content comprises the video cache size, and when the video cache size is less than a first preset threshold, increasing the radio resources to transmit video service information of the terminal; or
when the video cache size is greater than the first preset threshold, reducing or maintaining the radio resources to transmit the video service information of the terminal.

12. The method according to claim 9, wherein the scheduling radio resources according to the reported QoE information comprises:
when the reported content comprises the video cache size and the video total size, and when a ratio of the video cache size to the video total size is less than a second preset threshold, increasing the radio resources to transmit a video service information of the terminal; or
when the ratio of the video cache size to the video total size is greater than the second preset threshold, reducing or maintaining the radio resources to transmit the video service of the terminal.

13. The method according to claim 9, wherein the scheduling radio resources according to the reported QoE information comprises:
when the reported content comprises the video playing state, and when the video playing state is the emergency state, increasing the radio resources to transmit a video service information of the terminal; or
when the video playing state is the non-emergency state, reducing or maintaining the radio resources to transmit a video service information of the terminal.

14. The method according to claim 6, wherein before the delivering, by a network device, a QoE information reporting policy to a terminal, the method further comprises:
receiving a notification sent by the terminal that a current service type is a video service, and allocating initial radio resources to the terminal according to the notification, wherein the initial radio resources are used for initial caching of the video service of the terminal.

15. The method according to claim 14, wherein the receiving a notification sent by the terminal that a current service type is a video service comprises:
establishing, by the network device, a default bearer with the terminal, and receiving, by using RRC signaling, the notification sent by the terminal that the current service type is the video service, or receiving, by using a preset flow ID, the notification sent by the terminal that the current service type is the video service; or
establishing, by the network device, a dedicated bearer with the terminal, and receiving, by using a preset flow ID, the notification sent by the terminal that the current service type is the video service; or
receiving, by the network device, an initial data packet type reported by the terminal, to learn that the current service type is the video service.

16. An apparatus comprising:
a transmitter; and
a receiver, wherein
the receiver is configured to receive a QoE information reporting policy delivered by a network device; and
the transmitter is configured to report QoE information to the network device according to the QoE information reporting policy to enable the network device to schedule radio resources according to the reported QoE information.

17. The apparatus according to claim 16, wherein the apparatus further comprises a processor, wherein,
the receiver is further configured to receive a QoE information measurement policy delivered by the network device; and
the processor is configured to measure the QoE information according to the QoE information measurement policy.

18. The apparatus according to claim 17, wherein the QoE information measurement policy comprises measured content, and the measured content comprises: at least one of a video cache size, a video total size, video segment information, and a video playing state, wherein
the video segment information comprises information about at least one segment, the information about the at least one segment comprises at least one of a segment size and a starting and stopping time, and the video playing state includes an emergency state or a non-emergency state.

19. The apparatus according to claim 16, wherein the QoE information reporting policy comprises reported content, and the reported content comprises: at least one of a video cache size, a video total size, video segment information, and a video playing state, wherein
the video segment information comprises the information about the at least one segment, the information about the at least one segment comprises at least one of a segment size and a starting and stopping time, and the video playing state includes an emergency state or a non-emergency state.

20. The apparatus according to claim 19, wherein the QoE information reporting policy further comprises a reporting period, and the reporting period indicates a period length in which the apparatus reports the QoE information to the network device.
